(19) United States
(12) Patent Application Publication
(10) Pub. No.: US 2021/0292582 A1
(43) Pub. Date: Sep. 23, 2021

(54) INK, INK STORED CONTAINER, PRINTING DEVICE, AND PRINTING METHOD

(71) Applicant: RICOH COMPANY, LTD., Tokyo (JP)

(72) Inventors: Atsufumi HANAZAWA, Tokyo (JP); Yuuki YOKOHAMA, Kanagawa (JP); Takashi TAMAI, Kanagawa (JP); Yukihiro IMANAGA, Kanagawa (JP); Kento SUGITA, Tokyo (JP); Azumi MIYAAKE, Tokyo (JP); Sayuri KOJIMA, Kanagawa (JP); Toru YOSHIKAWA, Kanagawa (JP); Koichiro OYAMA, Kanagawa (JP); Satoshi TAKAHASHI, Kanagawa (JP); Mizuki KUROHA, Kanagawa (JP)

(21) Appl. No.: 17/197,284

(22) Filed: Mar. 10, 2021

(30) Foreign Application Priority Data
Mar. 17, 2020 (JP) 2020-045935
May 8, 2020 (JP) 2020-082538

(51) Int. Cl. C09D 11/322; B41J 2/175; C09D 11/38; C09D 11/033

(52) U.S. Cl. CPC C09D 11/322; B41J 2/17503; C09B 67/0013; C09D 11/033; C09D 11/38

(57) ABSTRACT

Provided is an ink including: a pigment-containing matter containing a pigment; an organic solvent; water; and a compound represented by General Formula (1) below. A difference (Ra−R₀) is 2.0 or less, where Ra is a distance between a Hansen solubility parameter of the organic solvent and a Hansen solubility parameter of the pigment-containing matter determined by a Hansen solubility sphere method, and R₀ is an interaction radius of the pigment-containing matter determined by the Hansen solubility sphere method.

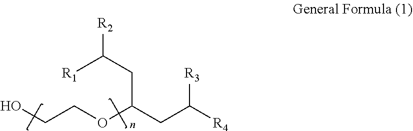

In the General Formula (1), R₁, R₂, R₃, and R₄ each independently represent a hydrogen atom or an alkyl group having 1 or more but 5 or less carbon atoms, and n represents an integer of 3 or more but 11 or less.

### CROSS-REFERENCE TO RELATED APPLICATIONS

The present application claims priority under 35 U.S.C. § 119 to Japanese Patent Application No. 2020-045935 filed Mar. 17, 2020 and Japanese Patent Application No. 2020-082538 filed May 8, 2020. The contents of which are incorporated herein by reference in their entirety.

### BACKGROUND OF THE INVENTION

### Field of the Invention

The present disclosure relates to an ink, an ink stored container, a printing device, and a printing method.

### Description of the Related Art

Inkjet printing devices have advantages such as low noise, low running cost, and ease of color printing and have become widespread in general households as digital signal output devices. In recent years, inkjet techniques have been utilized not only for home use but also for commercial applications and industrial applications.

Print media used for commercial applications and industrial applications may be coated paper (coat paper) for printing having low ink absorbability and plastic media having no ink absorbability. For these kinds of media, therefore, there is a demand to achieve image quality comparable to traditional offset printing by an inkjet printing method.

In addition, since commercial applications and industrial applications require high productivity, a line-head system, where printing is performed at one time with the inkjet head fixed, may be employed instead of a serial-head system, which is a traditional system where printing is performed by driving an inkjet head twice or more.

Japanese Unexamined Patent Application Publication No. 2018-104490 discloses an aqueous ink for inkjet printing including pigment (A), organic solvent (B), surfactant (C), and water. Specifically, it is disclosed that the surfactant (C) includes compound (C-1) that is one or more selected from polyoxyalkylene alkyl ether sulfate, polyoxyalkylene alkenyl ether sulfate, and polyoxyalkylene aryl ether sulfate, and compound (C-2) that is one or more selected from acetylene glycol and alkylene oxide adducts of acetylene glycol.

### SUMMARY OF THE INVENTION

According to one aspect of the present disclosure, an ink includes: a pigment-containing matter containing a pigment; an organic solvent; water; and a compound represented by General Formula (1) below. A difference (Ra−R₀) is 2.0 or less, where Ra is a distance between a Hansen solubility parameter of the organic solvent and a Hansen solubility parameter of the pigment-containing matter determined by a Hansen solubility sphere method, and R₀ is an interaction radius of the pigment-containing matter determined by the Hansen solubility sphere method.

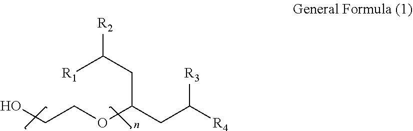

(In the above General Formula (1), R₁, R₂, and R₄ each independently represent a hydrogen atom or an alkyl group having 1 or more but 5 or less carbon atoms, and n represents an integer of 3 or more but 11 or less.)

### BRIEF DESCRIPTION OF THE DRAWINGS

FIG. 1 is a schematic view of one example of a printing device.

### DESCRIPTION OF THE EMBODIMENTS

Hereinafter, one embodiment of the present disclosure will be described.

### <<Ink>>

The ink in the present embodiment includes: a pigment-containing matter containing a pigment; an organic solvent; water; and a compound represented by General Formula (1), and has predetermined properties based on a Hansen solubility parameter (HSP). If necessary, the ink may include, for example, a resin, a surfactant, and other additives.

As used herein, the pigment-containing matter refers to a sole pigment, or a complex of a pigment and a substance existing integrally with the pigment in the ink. The substance existing integrally preferably has, for example, a function of imparting dispersibility to the pigment. Also, existing integrally is preferably a state, for example, where the substance existing integrally is physically or chemically bound or adsorbed to the pigment. The pigment-containing matter excludes any substance that does not exist integrally with the pigment. Thus, for example, resin particles added for the purpose of the functions such as a binder are not included in the pigment-containing matter.

The present disclosure has an object to prevent occurrence of color unevenness (beading) due to ununiform distribution of the pigment in an ink during from drying of the applied ink until fixation when the ink is applied onto a print medium to form a solid image.

The ink of the present disclosure exhibits an excellent effect of suppressing beading in an image formed with the ink.

### <Ink Properties Based on Hansen Solubility Parameter (HSP)>

First, a Hansen solubility parameter (HSP) will be described.

A Hansen solubility parameter (HSP) is an effective means for predicting compatibility between two kinds of substances and a parameter discovered by Charles M. Hansen. A Hansen solubility parameter (HSP) is expressed by combining the following three parameters (δD, δP, and δH) derived experimentally and theoretically. The unit used for the Hansen solubility parameter (HSP) is MPa^{0.5} or (J/cm³)^{0.5}. In the present embodiment, (J/cm³)^{0.5} is used as the unit.

δD: Energy attributable to London dispersion force

δP: Energy attributable to dipolar interaction

δH: Energy attributable to hydrogen bonding strength

The Hansen solubility parameter (HSP) is a vector quantity expressed as (δD, δP, δH), and plotted and expressed in a three-dimensional space (Hansen space) in which coordinate axes represent the three parameters. Substances commonly used have known information sources such as databases for the Hansen solubility parameter (HSP) thereof. Therefore, it is possible to obtain the Hansen solubility parameter (HSP) of a desired substance by, for example, consulting a database. The Hansen solubility parameter (HSP) of a substance whose Hansen solubility parameter (HSP) is not registered in any database can be calculated based on the chemical structure of the substance, using computer software such as Hansen Solubility Parameters in Practice (HSPiP). It is also possible to calculate a Hansen solubility parameter (HSP) by a Hansen solubility sphere method. The Hansen solubility parameter (HSP) of a mixture containing two or more kinds of substances is calculated as the vectorial sum of the products between the Hansen solubility parameters (HSPs) of the substances and the volume ratios of the substances with respect to the whole mixture.

Next, description will be given to a method for determining the Hansen solubility parameter (HSP) of a substance whose Hansen solubility parameter (HSP) is not known.

First, a substance whose Hansen solubility parameter (HSP) is to be determined and several kinds of evaluation solvents whose Hansen solubility parameters (HSPs) are known are provided to perform a compatibility test of the substance of interest with each of the evaluation solvents. In the compatibility test, a Hansen space is plotted with the Hansen solubility parameters (HSPs) of the evaluation solvents that exhibit compatibility and the Hansen solubility parameters (HSPs) of the evaluation solvents that do not exhibit compatibility. Based on the plotted Hansen solubility parameters (HSPs) of the evaluation solvents, a virtual sphere (Hansen sphere) is created on the Hansen space so as to include the Hansen solubility parameters (HSPs) of the evaluation solvents that exhibit compatibility and exclude the Hansen solubility parameters (HSPs) of the evaluation solvents that do not exhibit compatibility. The radius of the Hansen sphere is interaction radius R₀ of the substance and the center thereof is a Hansen solubility parameter (HSP) of the substance. Evaluators themselves set evaluation criteria of compatibility between the substance whose Hansen solubility parameter (HSP) is to be determined and the evaluation solvents whose Hansen solubility parameters (HSPs) are known (i.e., criteria for determining whether they dissolve in each other). The evaluation criteria in the present embodiment will be described below.

Next, description will be given to distance Ra between the Hansen solubility parameters (HSPs) of two kinds of substances. In general, as two kinds of substances are closer to each other in a three-dimensional space (Hansen space), these substances are more highly likely to dissolve in each other (to be compatible).

Assuming that the Hansen solubility parameters (HSPs) of two kinds of substance (substance A and substance B) are as follows, the distance Ra can be calculated in the following manner.

HSP^{A}=(δD^{A},δP^{A},δH^{A})

HSP^{B}=(δD^{B},δR^{B},δH^{B})

Ra=[4×(δD^{A}−δD^{B})²+(δP^{A}−δP^{B})²+(δH^{A}−δH^{B})²]^{1/2}

For the ink in the present embodiment, the difference (Ra−R₀) is 2.0 or less, preferably 0 or less, where Ra is a distance between a Hansen solubility parameter (HSP) of the organic solvent and a Hansen solubility parameter (HSP) of the pigment-containing matter determined by the above Hansen solubility sphere method, and R₀ is an interaction radius of the pigment-containing matter determined by the above Hansen solubility sphere method. When the difference (Ra−R₀) is 2.0 or less, even after water is evaporated from the ink droplets attached to a print medium, it is possible to suppress a decrease in dispersibility of the pigment-containing matter in the ink droplets. As a result, occurrence of beading is suppressed in an image formed with the ink. Also, when the difference (Ra−R₀) is 2.0 or less, even when the ink is used in an environment where water in the ink is easily evaporated such as in a long-term de-capped state, it is possible to suppress a decrease in dispersibility of the pigment-containing matter in the ink. As a result, a decrease in discharge restoration of the ink is suppressed. As used herein, the de-capped state refers to a state where a protection cap for suppressing drying of the ink in the nozzle of an inkjet head is not mounted to the inkjet head. Also, the discharge restoration preferably represents restoration of discharge stability of the ink to a practical level by conducting maintenances of the nozzles of the inkjet head (e.g., suctioning the ink from the nozzles, supplying the ink to the nozzles, and wiping the nozzle surfaces with a wiping member). More preferably, the discharge restoration represents restoration to the same level as that before being left in the de-capped state. The difference (Ra−R₀) is preferably −10.0 or more.

Here, detailed description will be given to how to determine the following (1) to (3) necessary for calculating the difference (Ra−R₀); (1) the Hansen solubility parameter (HSP) of the organic solvent; (2) the Hansen solubility parameter (HSP) of the pigment-containing matter determined by the Hansen solubility sphere method; and (3) the interaction radius R₀ of the pigment-containing matter determined by the Hansen solubility sphere method.

### —How to Determine (1) the Hansen Solubility Parameter (HSP) of the Organic Solvent—

The Hansen solubility parameter (HSP) of the organic solvent is calculated as the vectorial sum of the products between the Hansen solubility parameters (HSPs) of the organic solvents contained in the ink and the volume ratios of the organic solvents with respect to the whole organic solvents.

For example, when organic solvent x whose Hansen solubility parameter (HSP) is (δDx, δPx, δHx) and organic solvent y whose Hansen solubility parameter (HSP) is (δDy, δPy, δHy) are mixed at the following volume ratio; i.e., x:y=a:b, the Hansen solubility parameter (HSP) of the obtained organic solvent z is expressed as follows.

δDz=(a×δDx+b×δDy)/a+b

δPz=(a×δPx+b×δPy)/a+b

δHz=(a×δHx+b×δHy)/a+b

The amount of each of the organic solvents in the ink can be appropriately determined by a known method. An exemplary method is a method of diluting the ink with tetrahydrofuran and measuring the diluted ink through gas chromatography-mass spectrometry (GC-MS).

### —How to Determine (2) the Hansen Solubility Parameter (HSP) of the Pigment-Containing Matter and (3) the Interaction Radius R₀ of the Pigment-Containing Matter

### [1] Preparation of a Dispersion Liquid Containing the Pigment-Containing Matter

First, a dispersion liquid containing the pigment-containing matter and a dispersion medium is prepared. Specifically, the materials constituting the pigment-containing matter are added to a dispersion medium, so that the amount of the pigment-containing matter is 10% by mass or more but 35% by mass or less relative to the total amount of the dispersion liquid. The dispersion medium may be any liquid that prevents a pigment from aggregating and is appropriately selected from water and organic solvents. The dispersion medium preferably contains water, and more preferably contains water as a main component (which is, for example, 50% by mass or more relative to the total amount of the dispersion medium).

When a dispersion liquid containing the pigment-containing matter is prepared from an ink containing other components than the pigment-containing matter such as resin particles, the following method is employed, for example. First, the ink is diluted with tetrahydrofuran, and centrifuged to separate into two layers. The upper layer contains a large amount of other components than the pigment-containing matter such as resin particles, and the lower layer contains a large amount of the pigment-containing matter. The upper layer is discarded to leave only the lower layer, which is diluted again with tetrahydrofuran and centrifuged, followed by discarding the upper layer again. This series of operations is repeated. This procedure is performed until it is possible to determine that the lower layer consists substantially of the pigment-containing matter. After that, water is added to the lower layer, so that the amount of the lower layer (pigment-containing matter) is 10% by mass or more but 35% by mass or less relative to the total amount of the dispersion liquid. Whether it is possible to determine that the lower layer consists substantially of the pigment-containing matter is judged by evaporating and removing the dispersion medium from the lower layer, observing the solid component of the lower layer with an electron microscope, and confirming the proportion of particulate components other than the pigment-containing matter such as resin particles. Specifically, when the area of the particulate components other than the pigment-containing matter such as resin particles is 3% or smaller relative to the total area of the solid components in a scope observed with an electron microscope, it is judged that the lower layer consists substantially of the pigment-containing matter. When it is 3% or smaller, the results of the Hansen solubility parameter (HSP) determined in the following manner can be the same as the results obtained when the particulate components other than the pigment-containing matter such as resin particles are not contained at all (0%). A method for the centrifuge is, for example, a method of centrifuging for 3 hours at 15,000 rpm using HITACHI HIMAC CP100WX.

### [2] Evaluation of Compatibility Between a Dispersion Liquid Containing the Pigment-Containing Matter, and Evaluation Solvents

Next, the following 18 kinds of evaluation solvents whose Hansen solubility parameters (HSPs) are known are provided. Each of the evaluation solvents is added to the dispersion liquid containing the pigment-containing matter, followed by thoroughly dispersing, to prepare a liquid mixture. The amount of the evaluation solvent added is an amount in which the mass of the dispersion liquid is 20% of the mass of the liquid mixture. Then, the liquid mixture is left to stand still for 12 hours. The dispersion state of the liquid mixture after being left to stand still is visually observed to determine the presence or absence of aggregation.

### —Evaluation Solvents (18 Kinds)—

water, glycerin, 1,2-propanediol, 1,3-propanediol, 1,2-butanediol, 1,3-butanediol, 2,3-butanediol, propylene glycol, 1-methoxy-2-propanol, 3-methoxy-1-butanol, 3-methoxy-3-methyl-1-butanol, 2-pyrrolidone, 2-propanol, diethylene glycol, dipropylene glycol, 1,2-hexanediol, 3-ethyl-3-hydroxymethyloxetane, 3-methoxy-N,N-dimethylpropionamide

### [3] Calculation of Hansen Solubility Parameter (HSP) and Interaction Radius R₀ of the Pigment-Containing Matter

Next, based on the results obtained in the above [2], computer software, Hansen Solubility Parameters in Practice (HSPiP) is used to calculate the Hansen solubility parameter (HSP) and the interaction radius R₀ in the pigment-containing matter.

When the Fit determined using HSPiP is less than 0.8, the number of the kinds of evaluation solvents used in the [2] is increased so as to allow the Fit to be 0.8 or more.

### <Compound Represented by General Formula (1)>

The ink includes a compound represented by General Formula (1) below. The compound represented by General Formula (1) is a polyoxyalkylene alkyl ether. When the compound represented by General Formula (1) is included in the ink, ink dots formed after application of the ink on, for example, print media become easily wetted and spread. When the ink is uniformly and thinly spread on the surface of, for example, print media, the ink applied on the print media is dried for a shorter period of time. This suppresses ununiform distribution of the pigment in the ink during from drying of the applied ink until fixation. As a result, occurrence of color unevenness (beading) is suppressed in an image formed with the ink.

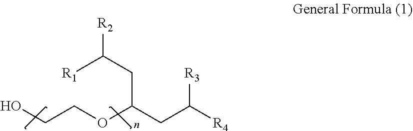

R₁, R₂, R₃, and R₄ in the General Formula (1) each independently represent a hydrogen atom or an alkyl group having 1 or more but 5 or less carbon atoms.

The alkyl group having from 1 through 5 carbon atoms may be a branched alkyl group or a non-branched alkyl group. Examples thereof include a methyl group, an ethyl group, a propyl group, an isopropyl group, a n-butyl group, a s-butyl group, an isobutyl group, a t-butyl group, a pentyl group, an isopentyl group, and a neopentyl group.

“n” in the General Formula (1) represents an integer of 3 or more but 11 or less, preferably an integer of 6 or more but 9 or less. When “n” is an integer of 3 or more but 11 or less, ink dots formed after application of the ink on, for example, print media become easily wetted and spread, and occurrence of beading is suppressed. When “n” is an integer of 6 or more but 9 or less, occurrence of beading is better suppressed.

The compound represented by the General Formula (1) is not particularly limited and may be appropriately selected depending on the intended purpose. It is preferably a compound represented by General Formula (2) below.

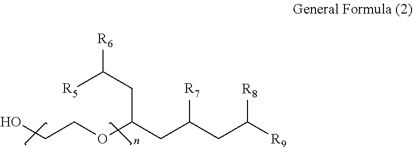

R₅, R₆, R₇, R₈, and R₉ in the General Formula (2) each independently represent a hydrogen atom or an alkyl group having 1 or more but 5 or less carbon atoms.

The alkyl group having from 1 through 5 carbon atoms may be a branched alkyl group or a non-branched alkyl group. Examples thereof include a methyl group, an ethyl group, a propyl group, an isopropyl group, a n-butyl group, a s-butyl group, an isobutyl group, a t-butyl group, a pentyl group, an isopentyl group, and a neopentyl group.

“n” in the General Formula (2) represents an integer of 3 or more but 11 or less, preferably an integer of 6 or more but 9 or less. When “n” is an integer of 3 or more but 11 or less, ink dots formed after application of the ink on, for example, print media become easily wetted and spread, and occurrence of beading is suppressed. When “n” is an integer of 6 or more but 9 or less, occurrence of beading is better suppressed.

The compound represented by the General Formula (1) is not particularly limited and may be appropriately selected depending on the intended purpose. It is more preferably a compound represented by General Formula (3) below. Examples of commercially available products included in the compound represented by the General Formula (3) include TRITON HW-1000, TMN-3, TMN-6, TMN-100X, and TMN-10 (all of which are available from The Dow Chemical Company).

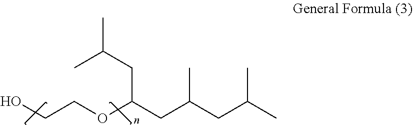

“n” in the General Formula (3) represents an integer of 3 or more but 11 or less, preferably an integer of 6 or more but 9 or less. When “n” is an integer of 3 or more but 11 or less, ink dots formed after application of the ink on, for example, print media become easily wetted and spread, and occurrence of beading is suppressed. When “n” is an integer of 6 or more but 9 or less, occurrence of beading is better suppressed.

The amount of the compound represented by the General Formula (1) is preferably 0.1% by mass or more but 2.0% by mass or less, more preferably 0.5% by mass or more but 1.5% by mass or less, relative to the mass of the ink. When it is 0.1% by mass or more but 2.0% by mass or less, ink dots formed after application of the ink on, for example, print media become easily wetted and spread, and occurrence of beading is suppressed.

### <Pigment-Containing Matter>

The ink includes the pigment-containing matter. The pigment-containing matter is, as described above, a sole pigment, or a complex of a pigment and a substance existing integrally with the pigment in the ink. The pigment and the substance existing integrally with the pigment are not particularly limited as long as the difference (Ra−R₀) is 2.0 or less, where Ra is a distance between a Hansen solubility parameter (HSP) of the organic solvent and a Hansen solubility parameter (HSP) of the pigment-containing matter determined by the Hansen solubility sphere method, and R₀ is an interaction radius of the pigment-containing matter determined by the Hansen solubility sphere method. The following materials can be used, for example.

### —Pigment—

The pigment may be inorganic pigments or organic pigments. These may be used alone or in combination. The pigment may also be mixed crystals.

Examples of the pigments include black pigments, yellow pigments, magenta pigments, cyan pigments, white pigments, green pigments, orange pigments, and gloss color pigments and metallic pigments of, for example, gold and silver.

Examples of the inorganic pigments include titanium oxide, iron oxide, calcium carbonate, barium sulfate, aluminum hydroxide, barium yellow, cadmium red, chrome yellow, and carbon black produced by known methods such as the contact method, the furnace method, and the thermal method.

Examples of the organic pigments include azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments having good affinity with solvents are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to: C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, 264, C.I. Pigment Violet 1 (Rohdamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63; C.I. Pigment Green 1, 4, 7, 8, 10, 17, 18, and 36.

The amount of the pigment is preferably 0.1% by mass or more but 15% by mass or less, more preferably 1% by mass or more but 10% by mass or less, relative to the mass of the ink, from the viewpoints of improvement in image density and favorable fixability and discharge stability.

—Substance Existing Integrally with the Pigment—

As described above, the substance existing integrally with the pigment preferably has a function of imparting dispersibility to the pigment. Also, existing integrally is preferably a state, for example, where the substance existing integrally is physically or chemically bound or adsorbed to the pigment. Examples of methods by which the substance existing integrally is physically or chemically bound or adsorbed to the pigment to impart dispersibility to the pigment include a method of coating the pigment surface with a resin for dispersing the pigment and a method of using a dispersant for dispersing the pigment.

Examples of the method of coating the pigment surface with a resin for dispersing the pigment include a method of encapsulating the pigment with the resin into microcapsules to be dispersible in water. This can also be referred to as a resin-coated pigment. In this case, not all of the pigments to be formulated into the ink need coating with the resin. An uncoated pigment or a partially coated pigment may be used.

Examples of the method of using a dispersant for dispersing the pigment include a method of dispersing the pigment using known low-molecular-weight dispersants or high-molecular-weight dispersants, typified by surfactants. The dispersant may be appropriately selected depending on the pigment. Usable dispersants include, for example, anionic surfactants, cationic surfactants, amphoteric surfactants, and nonionic surfactants.

—Method of Coating the Pigment Surface with a Resin for Dispersing the Pigment—

In the method of coating the pigment surface with a resin for dispersing the pigment, the resin is not particularly limited as long as it makes the pigment dispersible. For example, styrene-acrylic resins are preferably used.

Examples of the styrene-acrylic resins include styrene-acrylic acid copolymers, styrene-methacrylic acid copolymers, styrene-methacrylic acid-acrylic acid ester copolymers, styrene-α-methylstyrene-acrylic acid copolymers, and styrene-α-methylstyrene-acrylic acid-acrylic acid ester copolymers. Of these, styrene-acrylic acid copolymers are particularly preferable. The form of the copolymer may be any form of a random copolymer, a block copolymer, an alternating copolymer, and a graft copolymer.

The styrene-acrylic resin may contain components derived from monomers other than styrene-acrylic acid and methacrylic acid. Examples of such monomers include styrene derivatives such as α-methylstyrene, vinyltoluene, methyl (meth)acrylate, ethyl (meth)acrylate, n-propyl (meth)acrylate, isopropyl (meth)acrylate, n-butyl (meth)acrylate, sec-butyl (meth)acrylate, and tert-butyl (meth)acrylate. One or two or more kinds of these monomers may be added to the above styrene and acrylic acid or methacrylic acid monomer components.

The weight average molecular weight of the styrene-acrylic resin is preferably in the range of from 3,000 through 50,000, more preferably from 5,000 through 30,000. The styrene-acrylic resin used may be a commercially available product. Specific examples of the styrene-acrylic resin include JONCRYL 62J (available from BASF Japan Ltd.).

A method for producing a styrene-acrylic resin-coated pigment is not particularly limited. It can be produced in the following manner, for example. Specifically, the styrene-acrylic resin-coated pigment can be obtained by dispersing the pigment and the styrene-acrylic resin in a dispersion medium, followed by kneading.

### —Method of Using a Dispersant for Dispersing the Pigment—

In the method of using a dispersant for dispersing the pigment, the dispersant is not particularly limited as long as it makes the pigment dispersible. For example, a high-molecular-weight dispersant is preferably used. The high-molecular-weight dispersant is preferably a copolymer having a constituting unit represented by General Formula (4) below and a constituting unit represented by General Formula (5) below.

In the present embodiment, “constituting unit” refers to the minimum repeated unit of a polymer obtained by binding polymerizable monomers with each other.

The copolymer preferably has the constituting unit represented by the General Formula (4). When the copolymer has the constituting unit represented by the General Formula (4), ink dots formed after application of the ink on, for example, print media become easily wetted and spread. When the ink is uniformly and thinly spread on the surface of, for example, print media, the ink applied on the print media is dried for a shorter period of time. This suppresses ununiform distribution of the pigment in the ink during from drying of the applied ink until fixation. As a result, occurrence of color unevenness (beading) is suppressed in a solid image formed with the ink. Also, when the copolymer has the constituting unit represented by the General Formula (4), even when the ink is used in an environment where water in the ink is easily evaporated such as in a long-term de-capped state, it is possible to suppress a decrease in dispersibility of the pigment-containing matter in the ink. As a result, a decrease in discharge restoration of the ink is suppressed.

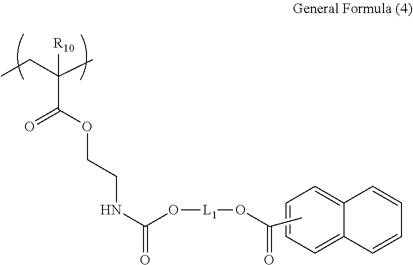

In the constituting unit represented by the General Formula (4), R₁₀ is a hydrogen atom or a methyl group. L₁ is an alkylene group having 2 or more but 18 or less carbon atoms, preferably an alkylene group having 2 or more but 16 or less carbon atoms, more preferably an alkylene group having 2 or more but 12 or less carbon atoms. When the number of carbon atoms is within the above ranges, a hydrophilic moiety and a hydrophobic moiety in the copolymer are located in an appropriate distance. Use of the copolymer as a pigment-dispersing resin can exhibit good dispersion stability.

In the constituting unit represented by the General Formula (4), the naphthyl group existing at the terminal via the alkyl group in a structure one of the terminals of which is an open end (in other words, a pendant structure) has an excellent pigment-adsorbing power through π-π stacking with the pigment that is a coloring material in the ink.

As is understood from the description of “the naphthyl group existing at the terminal via the alkyl group in a pendant”, the constituting unit represented by the General Formula (4) may typically be a main chain of a copolymer having pendant groups having the terminal naphthyl groups hanging down via the alkyl groups. However, needless to say, cases where parts of them are contained in side chains are not excluded.

For example, it is a well-known fact that there is difficulty in completely eliminating secondary radical polymerization reaction to produce branched structures.

Also, when using the copolymer in preparing a dispersion by dispersing the pigment in water, the copolymer easily adsorbs onto the pigment surfaces and has a high adsorbing power with the pigment because of the naphthyl groups existing at the terminals of the side chains of the copolymer. Thus, it is possible to obtain a highly dispersible dispersion that is stable for a long period of time.

The proportion of the constituting unit represented by the General Formula (4) in the copolymer is not particularly limited and may be appropriately selected depending on the intended purpose. It is preferably 60% by mass or more but 90% by mass or less relative to the total of the copolymer.

The copolymer preferably has a constituting unit represented by General Formula (5).

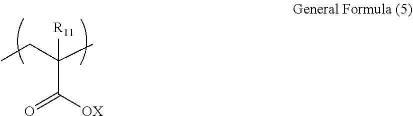

In the constituting unit represented by the General Formula (5), R₁₁ is a hydrogen atom or a methyl group. X is a hydrogen atom or a cation.

When X is a cation, the oxygen next to the cation exists as O⁻. Examples of the cation include a sodium ion, a potassium ion, a lithium ion, a tetramethylammonium ion, a tetraethylammonium ion, a tetrapropylammonium ion, a tetrabutylammonium ion, a tetrapentylammonium ion, a tetrahexylammonium ion, a triethylmethylammonium ion, a tributylmethylammonium ion, a trioctylmethylammonium ion, a 2-hydroxyethyltrimethylammonium ion, a tris(2-hydroxyethynmethylammonium ion, a propyltrimethylammonium ion, a hexyltrimethylammonium ion, an octyltrimethylammonium ion, a nonyltrimethylammonium ion, a decyltrimethylammonium ion, a dodecyltrimethylammonium ion, a tetradecyltrimethylammonium ion, a hexadecyltrimethylammonium ion, an octadecyltrimethylammonium ion, a didodecyldimethylammonium ion, a ditetradecyldimethylammonium ion, a dihexadecydimethylammonium ion, a diotadecyldimethylammonium ion, an ethylhexadecyldimethylammonium ion, an ammonium ion, a dimethylammonium ion, a trimethylammonium ion, a monoethylammonium ion, a diethylammonium ion, a triethylammonium ion, a monoethanolammonium ion, a diethanolammonium ion, a triethanolammonium ion, a methylethanolammonium ion, a methyldiethanolammonium ion, a dimethylethanolammonium ion, a monopropanolammonium ion, a dipropanolammonium ion, a tripropanolammonium ion, an isopropanolammonium ion, a morpholinium ion, an N-methylmorpholinium ion, an N-methyl-2-pyrrolidonium ion, and a 2-pyrrolidonium ion.

The proportion of the constituting unit represented by the General Formula (5) in the copolymer is not particularly limited and may be appropriately selected depending on the intended purpose. It is preferably 10% by mass or more but 40% by mass or less relative to the copolymer.

If necessary, the copolymer may include constituting units formed of other polymerizable monomers in addition to the constituting units represented by the above General Formulae (4) and (5). The other polymerizable monomers may be appropriately selected depending on the intended purpose. Examples thereof include polymerizable hydrophobic monomers, polymerizable hydrophilic monomers, and polymerizable surfactants.

### <Organic Solvent>

The organic solvent usable in the ink is not particularly limited as long as the difference (Ra−R₀) is 2.0 or less, where Ra is a distance between a Hansen solubility parameter (HSP) of the organic solvent and a Hansen solubility parameter (HSP) of the pigment-containing matter determined by the above Hansen solubility sphere method, and R₀ is an interaction radius of the pigment-containing matter determined by the above Hansen solubility sphere method. For example, the following materials can be used.

There is no specific limitation on the type of the organic solvent used in the present disclosure. For example, water-soluble organic solvents are suitable. Specific examples thereof include, but are not limited to, polyols, ethers such as polyol alkyl ethers and polyol aryl ethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, triethylene glycol, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenylether and ethylene glycol monobenzyl ether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethylpropioneamide, and 3-buthoxy-N,N-dimethylpropioneamide; amines such as monoethanolamine, diethanolamine, and triethylamine; sulfur-containing compounds such as dimethyl sulfoxide, sulfolane, and thiodiethanol; propylene carbonate, and ethylene carbonate. Since the water-soluble organic solvent serves as a humectant and also imparts a good drying property, it is preferable to use an organic solvent having a boiling point of 250 degrees C. or lower.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycol ether compounds include, but are not limited to, polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, propylene glycol monoethyl ether; and polyol aryl ethers such as ethylene glycol monophenyl ether and ethylene glycol monobenzyl ether. The polyol compounds having eight or more carbon atoms and glycol ether compounds enhance the permeability of ink when paper is used as a print medium.

Of these, the organic solvent contained in the ink is preferably at least one selected from the group consisting of 1,3-propanediol and glycerin. When the ink contains at least one selected from the group consisting of 1,3-propanediol and glycerin, even when the ink is used in an environment where water in the ink is easily evaporated such as in a long-term de-capped state, it is possible to suppress a decrease in dispersibility of the pigment-containing matter in the ink. As a result, a decrease in discharge restoration of the ink is suppressed.

The amount of the organic solvent in the ink is not particularly limited and may be appropriately selected depending on the intended purpose. In terms of drying properties and discharge reliability of the ink, it is preferably 10% by mass or more but 60% by mass or less, more preferably 20% by mass or more but 60% by mass or less, relative to the total amount of the ink.

### <Water>

The amount of water in the ink is not particularly limited and may be appropriately selected depending on the intended purpose. In terms of drying properties and discharge reliability of the ink, it is preferably 10% by mass or more but 90% by mass or less, more preferably 20% by mass or more but 60% by mass or less, relative to the total amount of the ink

### <Resin>

The type of the resin contained in the ink has no particular limit. Specific examples thereof include, but are not limited to, urethane resins, polyester resins, acrylic-based resins, vinyl acetate-based resins, styrene-based resins, butadiene-based resins, styrene-butadiene-based resins, vinyl chloride-based resins, acrylic styrene-based resins, and acrylic silicone-based resins.

Particles of such resins may be also used. It is possible to mix a resin emulsion in which the resin particles are dispersed in water serving as a dispersion medium with materials such as a coloring agent and an organic solvent to obtain ink. The resin particle can be synthesized or is available on the market. It is possible to synthesize the resin particle or obtain from market. These can be used alone or in combination of the resin particles.

The volume average particle diameter of the resin particle is not particularly limited and can be suitably selected to suit to a particular application. The volume average particle diameter is preferably 10 nm or more but 1,000 nm or less, more preferably 10 nm or more but 200 nm or less, and furthermore preferably 10 nm or more but 100 nm or less to obtain good fixability and image hardness.

The volume average particle diameter can be measured by using a particle size analyzer (Nanotrac Wave-UT151, manufactured by MicrotracBEL Corp.).

The proportion of the resin is not particularly limited and can be suitably selected to suit to a particular application. In terms of fixability and storage stability of the ink, it is preferably 1% by mass or more but 30% by mass or less and more preferably 5% by mass or more 20% by mass or less, relative to the total amount of the ink.

The particle diameter of the solid portion in ink has no particular limit. For example, the maximum frequency in the maximum number conversion is preferably 20 nm or more but 1,000 nm or less and more preferably 20 nm or more but 150 nm or less to ameliorate the discharging stability and image quality such as image density. The solid portion includes resin particles, particles of pigments, etc. The particle diameter of the solid portion can be measured by using a particle size analyzer (Nanotrac Wave-UT151, manufactured by MicrotracBEL Corp).

### <Surfactant>

Examples of the surfactant are silicone-based surfactants, fluorosurfactants, amphoteric surfactants, nonionic surfactants, anionic surfactants, etc.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluorosurfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorosurfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactants has no particular limit. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group is particularly preferable because such a surfactant demonstrates good characteristics as an aqueous surfactant.

Any suitably synthesized surfactant and any product thereof available on the market is suitable. Products available on the market are obtained from BYK Chemie Japan K.K., Shin-Etsu Silicone Co., Ltd., Dow Corning Toray Co., Ltd., etc., NIHON EMULSION Co., Ltd., Kyoeisha Chemical Co., Ltd., etc.

The polyether-modified silicon-based surfactant has no particular limit. For example, a compound in which the polyalkylene oxide structure represented by the following Chemical structure S-1 is introduced into the side chain of the Si site of dimethyl polysiloxane.

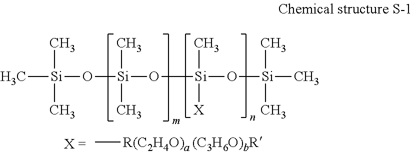

In the Chemical structure S-1, “m”, “n”, “a”, and “b” each, respectively represent integers, R represents an alkylene group, and R′ represents an alkyl group.

Specific examples of the polyether-modified silicon-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie K.K.), and TSF4440, TSF4452, and TSF4453 (all manufactured by Momentive Performance Materials Inc.).

A fluorosurfactant in which the number of carbon atoms replaced with fluorine atoms is from 2 to 16 is preferable and, 4 to 16, more preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not foam easily and the fluorosurfactant represented by the following Chemical formula F-1 or Chemical formula F-2 is more preferable.

CF₃CF₂(CF₂CF₂)ₘ—CH₂CH₂O(CH₂CH₂O)ₙH Chemical formula F-1

In the Chemical formula F-1, “m” is preferably 0 or an integer of from 1 to 10 and “n” is preferably 0 or an integer of from 1 to 40.

CₙH₂ₙ₊₁—CH₂CH(OH)CH₂—O—(CH₂CH₂O)ₙ—Y Chemical formula F-2

In the Chemical formula F-2, Y represents H, CmF₂ₘ₊₁, where “m” is an integer of from 1 to 6, H₂CH(OH)CH₂—CmF₂ₘ₊₁, where “m” represents an integer of from 4 to 6, or CₚH₂ₚ₊₁, where p represents an integer of from 1 to 19. “n” is an integer of from 1 to 6. “a” represents an integer of from 4 to 14.

Products available on the market may be used as the fluorosurfactant. Specific examples of the products available on the market include, but are not limited to, SURFLON S-111, SURFLON S-112, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, CAPSTONE FS-30, FS-31, FS-3100, FS-34, FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, PF-159 (manufactured by OMNOVA SOLUTIONS INC.), and UNIDYNE DSN-403N (manufactured by DAIKIN INDUSTRIES). Of these, FS-3100, FS-34, and FS-300 (all manufactured by The Chemours Company), FT-110, FT-250, FT-251, FT-400S, FT-150, and FT-400SW (manufactured by NEOS COMPANY LIMITED), PolyFox PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dyeing property to paper.

The proportion of the surfactant in the ink is not particularly limited. It is preferably 0.001% by mass or more but 5% by mass or less and more preferably 0.05% by mass or more but 5% by mass or less in terms of excellent wettability and discharging stability and improvement on image quality.

### <Other Additives>

If necessary, the ink may further contain a defoaming agent, a preservative and fungicide, a corrosion inhibitor, a pH regulator, etc.

### <Other Ink Properties>

The ink properties other than the above Hansen solubility parameter (HSP) are not particularly limited and may be appropriately selected depending on the intended purpose. For example, viscosity, surface tension, pH, etc., are preferably in the following ranges.

The viscosity of the ink at 25 degrees C. is preferably 5 mPa·s or more but 30 mPa·s or less and more preferably 5 mPa·s or more but 25 mPa·s or less to improve print density and text quality and obtain good dischargibility. The viscosity can be measured by, for example, a rotatory viscometer (RE-80L, manufactured by TOKI SANGYO CO., LTD.). The measuring conditions are as follows:
Standard cone rotor (1°34′×R24)
Sample liquid amount: 1.2 mL
Number of rotations: 50 rotations per minute (rpm)
25 degrees C.
Measuring time: three minutes

The surface tension of the ink is preferably 35 mN/m or less and more preferably 32 mN/m or less at 25 degrees C. in terms that the ink is suitably levelized on a print medium and the drying time of the ink is shortened.

The pH of the ink is preferably from 7 to 12 and more preferably from 8 to 11 in terms of prevention of corrosion of metal materials contacting the ink.

### <<Print Medium>>

The print medium is not particularly limited. Specific examples thereof include, but are not limited to, plain paper, gloss paper, special paper, and cloth. The ink can be particularly suitably used for low-permeating bases (low-absorbing bases).

The low-permeating base has a surface with low moisture permeability and absorbency and includes a material having myriad of hollow spaces inside but not open to the outside. Examples of the low-permeating base include, but are not limited to, print media such as coated paper used for commercial printing, and paperboard made of a middle layer and a back layer each containing waste paper pulp and of a coated surface.

The print medium may be, for example, a cut paper sheet printable per one printing unit, and a continuous paper sheet or a roll paper sheet printable with a plurality of printing units in the conveyance direction of the print medium.

### <Low-Permeating Base>

Examples of the low-permeating base include print media such as coated paper sheets each including a support, a surface layer provided on at least one surface of the support, and if necessary, further including other layers.

In the print medium including the support and the surface layer, the amount of pure water transferred to the print medium for a contact time of 100 ms as measured with a dynamic scanning absorptometer is preferably 2 mL/m² or more but 35 mL/m² or less, more preferably 2 mL/m² or more but 10 mL/m² or less.

When the amount of the ink and pure water transferred for a contact time of 100 ms is too small, beading may easily occur. When it is too large, the diameters of ink dots after image formation may become much smaller than the desired diameters.

The amount of pure water transferred to the print medium for a contact time of 400 ms as measured with a dynamic scanning absorptometer is preferably 3 mL/m² or more but 40 mL/m² or less, more preferably 3 mL/m² or more but 10 mL/m² or less.

When the amount thereof for a contact time of 400 ins is small, drying properties become insufficient. When it is too large, glossiness of an image portion after drying may be easily low. The amount of pure water transferred to the print medium for a contact time of 100 ms or 400 ms can be measured on the surface of the print medium at the side where the surface layer is provided.

It is noted that the dynamic scanning absorptometer (DSA: JAPAN TAPPI JOURNAL, Volume 48, May 1994, pp. 88-92, Shigenori Kuga) is an apparatus that can accurately measure the amount of a liquid absorbed during a very short period of time. The dynamic scanning absorptometer directly reads the absorption speed of a liquid from the movement of a meniscus in a capillary and automatically measures the amount of the liquid absorbed. The test sample is shaped like a disc. The dynamic scanning absorptometer scans one test sample by moving a liquid-absorbing head spirally over the test sample to thereby measure the amount of the liquid absorbed at as many points as necessary. The scanning speed is automatically changed according to a predetermined pattern.

A liquid supplying head that supplies liquid to the test sample is connected via a TEFLON (registered trademark) tube to the capillary. Positions of the meniscus in the capillary are automatically detected by an optical sensor. Specifically, the amount of the pure water or ink transferred was measured by a dynamic scanning absorptometer (K350 series, type D, available from Kyowa Co., Ltd.).

The amount of the pure water or ink transferred for a contact time of 100 ms or 400 ms can be obtained by interpolation, using the transfer amounts measured at time points around each contact time.

### —Support—

The support is not particularly limited and may be appropriately selected depending on the intended purpose. Examples of the material of the support include sheets of paper mainly made of wood fibers and nonwoven fabrics mainly made of wood and synthetic fibers.

The thickness of the support is not particularly limited and may be appropriately selected depending on the intended purpose. It is preferably from 50 μm through 300 μm. The basis weight of the support is preferably from 45 g/m² through 290 g/m².

### —Surface Layer—

The surface layer contains a pigment, a binder (binding agent) and if necessary, further contains a surfactant and other components.

The pigment may be an inorganic pigment or a mixture of an inorganic pigment and an organic pigment. Examples of the inorganic pigment include kaolin, talc, heavy calcium carbonate, precipitated calcium carbonate, calcium sulphite, amorphous silica, titanium white, magnesium carbonate, titanium dioxide, aluminum hydroxide, calcium hydroxide, magnesium hydroxide, zinc hydroxide, and chlorite. The amount of the inorganic pigment added is preferably 50 parts by mass or more relative to 100 parts by mass of the binder.

Examples of the organic pigment include water-soluble dispersions of, for example, styrene-acrylic copolymer particles, styrene-butadiene copolymer particles, polystyrene particles, and polyethylene particles. The amount of the organic pigment added is preferably from 2 parts by mass through 20 parts by mass relative to 100 parts by mass of the total pigment of the surface layer.

The binder is preferably an aqueous resin. The aqueous resin that is suitably usable is at least one selected from the group consisting of a water-soluble resin and a water-dispersible resin. The water-soluble resin is not particularly limited and may be appropriately selected depending on the intended purpose. Examples thereof include polyvinyl alcohol, cation-modified polyvinyl alcohol, acetal-modified polyvinyl alcohol, polyester, polyurethane, and mixtures of polyester and polyurethane.

The surfactant optionally contained in the surface layer is not particularly limited and may be appropriately selected depending on the intended purpose. It may be any one of an anionic surfactant, a cationic surfactant, an amphoteric surfactant, and a nonionic surfactant.

A method of forming the surface layer is not particularly limited and may be appropriately selected depending on the intended purpose. The surface layer can be formed by impregnating the support with the liquid to constitute the surface layer or by applying that liquid onto the support. The deposition amount of the liquid to constitute the surface layer is not particularly limited and may be appropriately selected depending on the intended purpose. It is preferably from 0.5 g/m² through 20 g/m², more preferably from 1 g/m² through 15 g/m², in terms of the solid content.

### <<Printing Device and Method>>

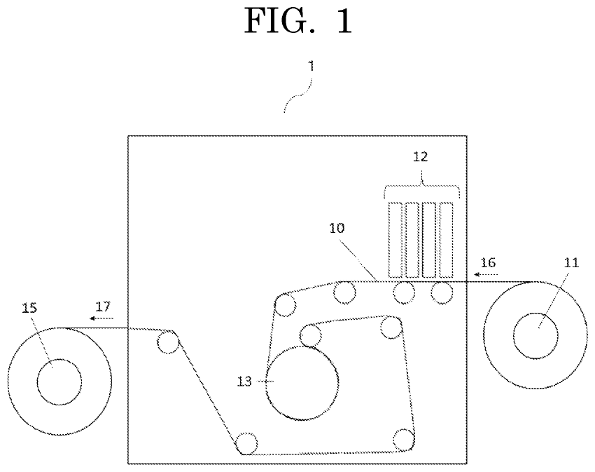

Referring to FIG. 1, a printing method and a printing device according to the present embodiment will be described. FIG. 1 is a schematic view of one example of a printing device.

A printing device 1 illustrated in FIG. 1 is a device configured to apply an ink to a print medium 10 to form an image on the print medium 10. The printing device 1 includes a paper feeding unit 11, an ink applying unit 12, a drying unit 13, and a roll-up unit 15.

### <Paper Feeding Unit and Step>

The paper feeding unit 11 is a unit configured to feed the print medium 1 to a position at which the ink applying unit 12 applies an ink. A paper feeding step as one step of the printing method can be suitably performed by the paper feeding unit.

The print medium 10 to be fed is preferably a continuous paper sheet. The continuous paper sheet is a print medium that is continuous in the conveyance direction at the time of image formation and is longer than the length of a print unit (1 page) in the conveyance direction. The length of the continuous paper sheet is preferably longer than the length of the conveyance path from the paper feeing unit 11 to the roll-up unit 15. The continuous paper sheet may be, for example, a rolled paper sheet rolled into a roll. In the example illustrated in FIG. 1, the print medium 10 that is rolled into a roll is set in the paper feeing unit 11. When the print medium 10 fed from the paper feeding unit 11 is rolled up using the roll-up unit 15, the print medium 10 is conveyed in the conveyance direction (in the direction indicated by arrow 16 and arrow 17 in FIG. 1). The print medium 10 is not limited to the continuous paper sheet and may be a cut paper sheet. The cut paper sheet is a print medium that is independent per a print unit (1 page) in the conveyance direction at the time of image formation.

### <Ink Applying Unit and Step>

The ink applying unit 12 is a unit configured to apply an ink to the print medium 10, which is fed from the paper feeding unit 11 in the direction indicated by arrow 16, to form an image. The ink applying unit 12 is preferably a head unit composed of an inkjet line head of a single-pass system. In the case of a unit configured to apply an ink by an inkjet printing method, the unit preferably has four discharge heads corresponding to inks of black (K), cyan (C), magenta (M), and yellow (Y). Besides, the unit may have discharge heads for special inks of, for example, orange (O) and green (G) and a discharge head configured to discharge post-treatment liquid for imparting glossiness and other treatments. In addition to the inkjet printing method, the unit configured to apply an ink may use, for example, a blade coating method, a gravure coating method, a bar coating method, a roll coating method, a dip coating method, a curtain coating method, a slide coating method, a die coating method, and a spray coating method. An ink applying step as one step of the printing method can be suitably performed by the ink applying unit.

The size of the droplets to be discharged is preferably, for example, 2 pL or more but 40 pL or less. The discharge speed by jetting is preferably 5 m/s or more but 20 m/s or less. The drive frequency is preferably 1 kHz or more. The resolution is preferably 300 dpi or more.

Each of the above discharge heads receives an ink from an ink container containing an ink (one example of the ink stored container). The ink container may be any container as long as it can store an ink therein. Examples thereof include cartridges having casings of, for example, a resin, and bottles. The cartridge may be an aluminum pouch including an ink-stored inner bag made of a resin such as polyethylene.

### <Drying Unit and Step>

The drying unit 13 is a unit configured to dry the ink applied to the print medium 10 from the ink applying unit 12. The drying unit 13 is preferably a heat drum configured to come into contact with the surface of the print medium 10 to which no ink is applied, to heat the surface. The temperature of the heat drum, which depends on the printing speed and drying properties of the ink, is preferably 100° C. or higher but 130° C. or lower. Examples of other drying units that can be used in combination with drying by the heat drum include units using hot-air heating, infrared irradiation, and UV irradiation, and combined units thereof. A drying step as one step of the printing method can be suitably performed by the drying unit.

### <Roll-Up Unit and Step>

The roll-up unit 15 is disposed at a position opposite to the paper feeding unit 11 and is a unit configured to roll up the print medium 10 fed from the paper feeding unit 11 and having a printed layer. By adjusting the rotation speeds of the paper feeding unit 11 and the roll-up unit 15, it is possible to adjust the tension acting on the print medium 10. Depending on the kind of the print medium, the paper feeding unit and the roll-up unit can be omitted. A roll-up step as one step of the printing method can be suitably performed by the roll-up unit.

### <Others>

This printing device may include not only parts to discharge the ink but also, for example, devices called a pre-treatment device and a post-treatment device.

Similar to the cases of the inks of, for example, black (K), cyan (C), magenta (M), and yellow (Y), one embodiment of the pre-treatment device or the post-treatment device is where a liquid stored part containing a pre- or post-treatment liquid and a liquid discharging head are additionally provided to discharge the pre- or post-treatment liquid by an inkjet printing method.

Other embodiments of the pre-treatment device or the post-treatment device are where a pre- or post-treatment device for, for example, a blade coating method, a roll coating method, or a spray coating method other than the inkjet printing method is provided.

### EXAMPLES

The present disclosure will be described below by way of Examples, but should not be construed as being limited to these Examples in any way

### <Synthesis Examples of Copolymer A>

62.0 g (525 mmol) of ethylene glycol (obtained from Tokyo Chemical Industry) was dissolved in 700 mL of methylene chloride, followed by addition of 20.7 g (262 mmol) of pyridine. To this solution, a solution prepared by dissolving 50.0 parts by mass (262 mmol) of 2-naphthalenecarbonyl chloride (obtained from Tokyo Chemical Industry) in 100 mL of methylene chloride was dropped under stirring for 2 hours, followed by stirring at room temperature for 6 hours. The obtained reaction solution was washed with water, and then the organic phase was isolated and dried with magnesium sulfate, and the solvent was evaporated. The residue was purified through silica gel column chromatography using a methylene chloride/methanol (volume ratio: 98/2) solvent mixture as an eluent, to obtain 52.5 parts by mass of 2-naphthoic acid-2-hydroxyethyl ester.

Next, 42.1 parts by mass (155 mmol) of 2-naphthoic acid-2-hydroxyethyl ester was dissolved in 80 mL of dry methyl ethyl ketone, followed by heating to 60° C. To this solution, a solution prepared by dissolving 24.0 parts by mass (155 mmol) of 2-methacryloyloxyethyl isocyanate (obtained from SHOWA DENKO K.K., KARENZ MOI) in 20 mL of dry methyl ethyl ketone was dropped under stirring for 1 hour, followed by stirring at 70° C. for 12 hours. After cooling to room temperature, the solvent was evaporated. The residue was purified through silica gel column chromatography using a methylene chloride/methanol (volume ratio: 99/1) solvent mixture as an eluent, to obtain 57.0 parts by mass of a monomer represented by Structural Formula (1) below.

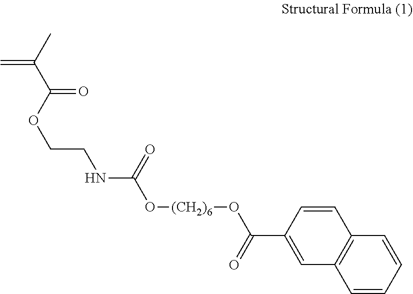

Next, 1.30 parts by mass (22.0 mmol) of acrylic acid (obtained from Aldrich Co.) and 6.29 parts by mass (14.7 mmol) of the monomer represented by the above Structural Formula (1) were dissolved in 40 mL of dry methyl ethyl ketone to prepare a monomer solution. 10% by mass of the monomer solution was heated to 75° C. under an argon stream. A solution prepared by dissolving 0.273 parts by mass (1.67 mmol) of 2,2′-azoiso(butyronitrile) (obtained from Tokyo Chemical Industry) in the remaining monomer solution was dropped for 1.5 hours, followed by stirring at 60° C. for 11 hours. After cooling to room temperature, the obtained reaction solution was charged to hexane. The copolymer that precipitated was separated through filtration and dried under reduced pressure, to obtain 8.13 parts by mass of the copolymer.

The obtained copolymer was dissolved in an aqueous dimethylethanolamine solution so as to be 100% neutralized. Furthermore, the concentration of the copolymer was adjusted with ion-exchanged water so that the concentration would be 10% by mass, to obtain Copolymer a.

The obtained Copolymer a was measured using GPC, and the weight average molecular weight was found to be 20,000. The Copolymer a was measured for acid value through acid value titration, and the acid value was found to be 160 mgKOH/g.

### <Preparation Examples of Pigment Dispersion 1>

Cyanine Blue A220JC (C.I. Pigment Blue 15:3, Dainichiseika Color & Chemicals Mfg. Co., Ltd.): 15.0 parts by mass

Copolymer a (copolymer concentration: 10% by mass): 37.5 parts by mass

Ion-Exchanged Water: 47.5 Parts by Mass

Copolymer a was added to and dissolved in ion-exchanged water. Cyanine Blue A220JC was mixed with the resultant solution. After stirred and sufficiently wetted, the mixture was kneaded at 2,000 rpm for 20 minutes using kneader DYNO-MILL model KDL A (obtained from WAB Inc.) that had been charged with zirconia beads having diameters of 0.2 mm. The mill base was taken out and filtrated through a filter having an average pore diameter of 1 μm, to obtain Pigment Dispersion 1 containing a pigment-containing matter (the concentration of the pigment-containing matter: 18.75% by mass).

### <Preparation Examples of Pigment Dispersion 2>

Inkjet Magenta E5B 02 (C.I. Pigment Violet 19, obtained from Clariant Japan K.K.): 15.0 parts by mass

Copolymer a (copolymer concentration: 10% by mass): 37.5 parts by mass

Ion-exchanged water: 47.5 parts by mass

Copolymer a was added to and dissolved in ion-exchanged water. Inkjet Magenta E5B 02 was mixed with the resultant solution. After stirred and sufficiently wetted, the mixture was kneaded at 2,000 rpm for 60 minutes using kneader DYNO-MILL model KDL A (obtained from WAB Inc.) that had been charged with zirconia beads having diameters of 0.2 mm. The mill base was taken out and filtrated through a filter having an average pore diameter of 1 μm, to obtain Pigment Dispersion 2 containing a pigment-containing matter (the concentration of the pigment-containing matter: 18.75% by mass).

### <Synthesis Example of Copolymer B>

550 g of methyl ethyl ketone was charged into a reaction container of an automated polymerization reaction apparatus (obtained from TODOROKI SANGYO CO., LTD.: polymerization tester model DSL-2AS) including a reaction container equipped with a stirring device, a dropping device, a temperature sensor, and a reflux device having a nitrogen introducing device above the reflux device. The reaction container was purged with nitrogen under stirring. With the interior of the reaction container kept to be the nitrogen atmosphere, the temperature was increased to 80° C. After that, the dropping device was used to drop a solvent mixture of 75.0 g of 2-hydroxyethyl methacrylate, 77.0 g of methacrylic acid, 80.0 g of styrene, 150.0 g of butyl methacrylate, 98.0 g of butyl acrylate, 20.0 g of methyl methacrylate, and 40.0 g of “PERBUTYL (registered trademark) 0” (obtained from NOF CORPORATION) for 4 hours. After completion of dropping, the reaction was allowed to further continue at the same temperature for 15 hours, to obtain methyl ethyl ketone B liquid of anionic group-containing styrene-acrylic copolymer A having an acid value of 100, a weight average molecular weight of 21,000, and a Tg (calculated value) of 31° C. After completion of reaction, part of the methyl ethyl ketone was evaporated under reduced pressure, to obtain a Copolymer b solution in which the non-volatile components was adjusted to 50%.

### <Preparation Example of Pigment Dispersion 3>

A mixing vessel equipped with a cooling jacket was charged with 1,000 g of copper phthalocyanine (obtained from Dainichiseika Color & Chemicals Mfg. Co., Ltd., SEIKALIGHT BLUE A612), 800 g of the Copolymer b solution, 143 g of a 10% aqueous sodium hydroxide solution. 100 g of methyl ethyl ketone, and 1,957 g of water, followed by stirring and mixing. The liquid mixture was allowed to pass through a dispersing device (obtained from NIPPON COKE & ENGINEERING CO., LTD.: SC MILL SC100) charged with zirconia beads having diameters of 0.3 mm and was dispersed for 6 hours in a circulating manner (a manner in which a dispersion liquid released from the dispersing device is returned to the mixing vessel). The number of rotations of the dispersing device was set to 2,700 rotations/minute. Cool water was allowed to pass through the cooling jacket so as to keep the temperature of the dispersion liquid to be 40° C. or lower. After completion of dispersing, a fleshly dispersed liquid was taken out from the mixing vessel. Then, 10,000 g of water was used to wash the mixing vessel and the channel of the dispersing device, and the wash liquid was combined with the fleshly dispersed liquid to obtain a diluted dispersion liquid. The diluted dispersion liquid was charged to a distillation device made of glass, to distill off the total of the methyl ethyl ketone and part of the water. After cooling to room temperature, 10% chloric acid was dropped under stirring to adjust the pH to 4.5. After that, the solids were filtrated by a Nutsche-type filtration device (obtained from Japan Chemical Engineering & Machinery Co., Ltd., a pressure filtration machine), followed by washing with water. The cake was taken into a container. 200 g of a 20% aqueous potassium hydroxide solution was added to the container. The resultant mixture was dispersed by DISPER (obtained from PRIMIX Corporation, TK homodisper), followed by further addition of water to adjust the non-volatile components. The procedure described above gave Pigment Dispersion 3 (the concentration of the pigment-containing matter: 20.0% by mass) containing composite particles which were the copper phthalocyanine coated with the carboxyl group-containing styrene-acrylic copolymer neutralized in potassium hydroxide (the pigment-containing matter).

### <Ink Preparation Example>

### —Preparation of Ink 1—

1,3-Propanediol (35.0% by mass), polyoxyalkylene alkyl ether (product name: TRITON HW-1000, a compound represented by General Formula (3) where n is 6, obtained from The Dow Chemical Company) (1.0% by mass), and ion-exchanged water were stirred for 1 hour and homogeneously mixed. A rosin-modified maleic acid resin (obtained from Harima Chemicals Group, Inc.: HARIMACK R-100) (2.0% by mass) was added, and the resultant mixture was further stirred for 1 hour and homogeneously mixed. After that, Pigment Dispersion 1 (30.0% by mass) was added, and the resultant mixture was further stirred for 1 hour and homogeneously mixed. This mixture was filtrated under pressure through a polyvinylidene fluoride membrane filter having an average pore diameter of 0.8 μm for removal of coarse particles and dust, to obtain Ink 1.

### —Preparation of Inks 2 to 28—

Inks 2 to 28 were obtained in the same manner as in the Preparation of Ink 1 except that the components and amounts thereof were changed to those in Tables 1 to 3 below. Incidentally, the units of the numerical values of the amounts of the components in Tables 1 to 3 are “% by mass”.

TABLE 1

| | | Ink | | | | | | | | | |
|---|---|---|---|---|---|---|---|---|---|---|---|
| | | 1 | 2 | 3 | 4 | 5 | 6 | 7 | 8 | 9 | 10 |
| Organic | 1,3-Propanediol | 35.0 | 35.0 | 35.0 | 35.0 | 35.0 | 35.0 | 35.0 | 25.0 | 45.0 | 17.5 |
| solvent | 1,2-Propanediol | | | | | | | | | | |
| | Glycerin | | | | | | | | | | 17.5 |
| | 1,2-Butanediol | | | | | | | | | | |
| | Dipropylene glycol | | | | | | | | | | |
| | 2,3-Butanediol | | | | | | | | | | |
| | 3-Methyl-1,3-butanediol | | | | | | | | | | |
| | Diethylene glycol | | | | | | | | | | |
| Coloring | Pigment Dispersion 1 | 30.0 | 30.0 | 30.0 | 30.0 | 30.0 | 20.0 | 40.0 | 30.0 | 30.0 | 30.0 |
| material | Pigment Dispersion 2 | | | | | | | | | | |
| | Pigment Dispersion 3 | | | | | | | | | | |
| General | HW-1000 [n = 6] | 1.0 | | | | | 1.0 | 1.0 | 1.0 | 1.0 | 1.0 |
| Formula | TMN-3 [n = 3] | | 1.0 | | | | | | | | |
| (1) | TMN-6 [n = 8] | | | 1.0 | | | | | | | |
| | TMN-100X [n = 9] | | | | 1.0 | | | | | | |
| | TMN-10 [n = 11] | | | | | 1.0 | | | | | |
| Surfactant | Sodium polyoxyethylene | | | | | | | | | | |
| | lauryl ether sulfate | | | | | | | | | | |
| | SURFYNOL 420 | | | | | | | | | | |
| Resin | Rosin-modified maleic | 2.0 | 2.0 | 2.0 | 2.0 | 2.0 | 2.0 | 2.0 | 2.0 | 2.0 | 2.0 |
| | acid resin | | | | | | | | | | |
| Water | Ion-exchanged water | Balance | Balance | Balance | Balance | Balance | Balance | Balance | Balance | Balance | Balance |

| | | | | | | | | | | |
|---|---|---|---|---|---|---|---|---|---|---|
| Total (% by mass) | 100 | 100 | 100 | 100 | 100 | 100 | 100 | 100 | 100 | 100 |

TABLE 2

| | | Ink | | | | | | | | | |
|---|---|---|---|---|---|---|---|---|---|---|---|
| | | 11 | 12 | 13 | 14 | 15 | 16 | 17 | 18 | 19 | 20 |
| Organic | 1,3-Propanediol | | | | | | | | 35.0 | 35.0 | |
| solvent | 1,2-Propanediol | 35.0 | | | | | | | | | 35.0 |
| | Glycerin | | 35.0 | | | | | | | | |
| | 1,2-Butanediol | | | 35.0 | | | | | | | |
| | Dipropylene glycol | | | | 35.0 | | | | | | |
| | 2,3-Butanediol | | | | | 35.0 | | | | | |
| | 3-Methyl-1,3-butanediol | | | | | | 35.0 | | | | |
| | Diethylene glycol | | | | | | | 35.0 | | | |
| Coloring | Pigment Dispersion 1 | 30.0 | 30.0 | 30.0 | 30.0 | 30.0 | 30.0 | 30.0 | | | |
| material | Pigment Dispersion 2 | | | | | | | | 22.5 | | |
| | Pigment Dispersion 3 | | | | | | | | | 22.5 | 22.5 |
| General | HW-1000 [n = 6] | 1.0 | 1.0 | 1.0 | 1.0 | 1.0 | 1.0 | 1.0 | 1.0 | 1.0 | 1.0 |
| Formula | TMN-3 [n = 3] | | | | | | | | | | |
| (1) | TMN-6 [n = 8] | | | | | | | | | | |
| | TMN-100X [n = 9] | | | | | | | | | | |
| | TMN-10 [n = 11] | | | | | | | | | | |
| Surfactant | Sodium polyoxyethylene | | | | | | | | | | |
| | lauryl ether sulfate | | | | | | | | | | |
| | SURFYNOL 420 | | | | | | | | | | |
| Resin | Rosin-modified maleic | 2.0 | 2.0 | 2.0 | 2.0 | 2.0 | 2.0 | 2.0 | 2.0 | 2.0 | 2.0 |
| | acid resin | | | | | | | | | | |
| Water | Ion-exchanged water | Balance | Balance | Balance | Balance | Balance | Balance | Balance | Balance | Balance | Balance |

| | | | | | | | | | | |
|---|---|---|---|---|---|---|---|---|---|---|
| Total (% by mass) | 100 | 100 | 100 | 100 | 100 | 100 | 100 | 100 | 100 | 100 |

TABLE 3

| | | Ink | | | | | | | |
|---|---|---|---|---|---|---|---|---|---|
| | | 21 | 22 | 23 | 24 | 25 | 26 | 27 | 28 |
| Organic | 1,3-Propanediol | | | | | | | 35.0 | |
| solvent | 1,2-Propanediol | | | | | | | | 10.0 |
| | Glycerin | 35.0 | | | | | | | 2.0 |
| | 1,2-Butanediol | | 35.0 | | | | | | |
| | Dipropylene glycol | | | 35.0 | | | | | |
| | 2,3-Butanediol | | | | 35.0 | | | | |
| | 3-Methyl-1,3-butanediol | | | | | 35.0 | | | |
| | Diethylene glycol | | | | | | 35.0 | | |
| Coloring | Pigment Dispersion 1 | | | | | | | | 5.0 |
| material | Pigment Dispersion 2 | | | | | | | | |
| | Pigment Dispersion 3 | 22.5 | 22.5 | 22.5 | 22.5 | 22.5 | 22.5 | 22.5 | 22.5 |
| General | HW-1000 [n = 6] | 1.0 | 1.0 | 1.0 | 1.0 | 1.0 | 1.0 | | |
| Formula | TMN-3 [n = 3] | | | | | | | | |
| (1) | TMN-6 [n = 8] | | | | | | | | |
| | TMN-100X [n = 9] | | | | | | | | |
| | TMN-10 [n = 11] | | | | | | | | |
| Surfactant | Sodium polyoxyethylene | | | | | | | 1.5 | 1.5 |
| | lauryl ether sulfate | | | | | | | | |
| | SURFYNOL 420 | | | | | | | 1.2 | 1.2 |
| Resin | Rosin-modified maleic | 2.0 | 2.0 | 2.0 | 2.0 | 2.0 | 2.0 | 2.0 | 2.0 |
| | acid resin | | | | | | | | |
| Water | Ion-exchanged water | Balance | Balance | Balance | Balance | Balance | Balance | Balance | Balance |

| | | | | | | | | |
|---|---|---|---|---|---|---|---|---|
| Total (% by mass) | 100 | 100 | 100 | 100 | 100 | 100 | 100 | 100 |

The components in Tables 1 to 3 are the following materials.

TMN-3 (a compound represented by General Formula (3) where n is 3, obtained from The Dow Chemical Company)

TMN-6 (a compound represented by General Formula (3) where n is 8, obtained from The Dow Chemical Company)

TMN-100X (a compound represented by General Formula (3) where n is 9, obtained from The Dow Chemical Company)

TMN-10 (a compound represented by General Formula (3) where n is 11, obtained from The Dow Chemical Company)

Sodium polyoxyethylene lauryl ether sulfate (average number of moles of ethylene oxide: 18 moles)

SURFYNOL 420 (obtained from Air Products and Chemicals, Inc.)

### <Measurements of Hansen Solubility Parameter (HSP) and Interaction Radius R₀ of the Pigment-Containing Matter>

Following steps [1] to [3] below, the Hansen solubility parameter (HSP) and the interaction radius R₀ of the pigment-containing matter were determined.

### [1] Preparation of Dispersion Liquid Containing the Pigment-Containing Matter

First, an aqueous dispersion liquid containing the pigment-containing matter was provided. Specifically, the amount of the pigment-containing matter was adjusted to 30% by mass relative to the total amount of each of Pigment Dispersions 1 to 3.

### [2] Evaluation of Compatibility Between Dispersion Liquid Containing the Pigment-Containing Matter, and Evaluation Solvents.

Next, the following 18 kinds of evaluation solvents whose Hansen solubility parameters (HSPs) are known were provided. Each of the evaluation solvent was added to the aqueous dispersion liquid containing the pigment-containing matter, followed by thoroughly dispersing, to prepare a liquid mixture. The amount of the evaluation solvent added was an amount in which the mass of the aqueous dispersion liquid would be 20% of the mass of the liquid mixture. Then, the liquid mixture was left to stand still for 12 hours. The dispersion state of the liquid mixture after being left to stand still was visually observed to determine the presence or absence of aggregation.

### —Evaluation Solvents (18 Kinds)—

water, glycerin, 1,2-propanediol, 1,3-propanediol, 1,2-butanediol, 1,3-butanediol, 2,3-butanediol, propylene glycol, 1-methoxy-2-propanol, 3-methoxy-1-butanol, 3-methoxy-3-methyl-1-butanol, 2-pyrrolidone, 2-propanol, diethylene glycol, dipropylene glycol, 1,2-hexanediol, 3-ethyl-3-hydroxymethyloxetane, 3-methoxy-N,N-dimethylpropionamide

### [3] Calculation of Hansen Solubility Parameter (HSP) and Interaction Radius R₀ of the Pigment-Containing Matter

Next, based on the results obtained in the above [2], computer software, Hansen Solubility Parameters in Practice (HSPiP) was used to calculate the Hansen solubility parameter (HSP) and the interaction radius R₀ in the pigment-containing matter. Results are presented below. The following numerical values in parentheses represent a vector quantity (δD, δP, δH) of the Hansen solubility parameter (HSP).

### —Pigment Dispersion 1—

Hansen solubility parameter (HSP): (16.0, 12.8, 32.1)

Interaction radius R₀: 10.1

### —Pigment Dispersion 2—

Hansen solubility parameter (HSP): (16.6, 12.5, 31.9)

Interaction radius R₀: 11.0

### —Pigment Dispersion 3—

Hansen solubility parameter (HSP): (12.0, 24.5, 27.2)

Interaction radius R₀: 17.1

### <Calculation of Difference (Ra−R₀)>

First, the Hansen solubility parameter (HSP) of the organic solvent in each of the inks was determined. The Hansen solubility parameter (HSP) of the organic solvent was calculated as the vectorial sum of the products between the Hansen solubility parameters (HSPs) of the organic solvents in the ink and the volume ratios of the organic solvents with respect to the whole organic solvents.

Next, the distance Ra was calculated based on the Hansen solubility parameter (HSP) of the organic solvent and the above Hansen solubility parameter (HSP) of the pigment-containing matter. Moreover, the difference (Ra−R₀) was calculated based on the distance Ra and the above interaction radius R₀. Results are presented in Table 4.

Each of the obtained inks was evaluated for “beading” and “discharge restoration” in the following manners. Results are presented in Table 4.

### [Beading]

A printing device illustrated in FIG. 1 was used to discharge the ink onto a print medium (obtained from Oji Paper Co., Ltd.: OK TOPCOAT+[basis weight: 127.8 gsm]). In a drying step, the print medium was dried by hot air of 100° C. and contact with a heating roller of 100° C. for 10 seconds, to obtain a print sample. An ink applying unit used for the printing device was the head mounted in an inkjet printing device (IPSIO GXe-5500: obtained from Ricoh Company, Limited). A print chart was a 3 cm×3 cm solid image formed of dot patterns. Next, the print sample was visually observed for the 3 cm×3 cm solid image formed of dot patterns, to evaluate “beading” according to the following evaluation criteria. Ranks A and B are preferable.

### (Evaluation Criteria)

A: Beading was not observable from a distance of 20 cm.

B: Beading was slightly observable from a distance of 20 cm.

C: Beading was clearly observable from a distance of 20 cm.

### [Discharge Restoration]

The head of an inkjet printing device (IPSIO GXe-5500: obtained from Ricoh Company, Limited) was left to stand still in the de-capped state for 10 hours. After that, head cleaning was performed once, and a nozzle check chart was printed on a print medium (obtained from Oji Paper Co., Ltd.: OK TOPCOAT+[basis weight: 127.8 gsm]). Dots forming the obtained nozzle check chart were observed to confirm the presence or absence of discharge abnormality in the nozzles. When the discharge abnormality was confirmed, twice more head cleaning operations were performed, and again a nozzle check chart was printed on a print medium (obtained from Oji Paper Co., Ltd.: OK TOPCOAT+[basis weight: 127.8 gsm]). Dots forming the obtained nozzle check chart were observed to confirm the presence or absence of discharge abnormality in the nozzles, to evaluate “discharge restoration” according to the following evaluation criteria. Ranks A and B are preferable.

### (Evaluation Criteria)

A: No discharge abnormality was confirmed in all of the nozzles by the cleaning operation performed once.

B: No discharge abnormality was confirmed in all of the nozzles by the cleaning operations performed three times.

C: Discharge abnormality was confirmed in some of the nozzles even by the cleaning operations performed three times.

TABLE 4

Evaluation Results

| | | Difference | | Discharge |
|---|---|---|---|---|
| | Ink | (Ra − R₀) | Beading | restoration |
| Ex. 1 | 1 | −1.0 | A | A |
| Ex. 2 | 2 | −1.0 | B | A |
| Ex. 3 | 3 | −1.0 | A | A |
| Ex. 4 | 4 | −1.0 | A | A |
| Ex. 5 | 5 | −1.0 | B | A |
| Ex. 6 | 6 | −1.0 | A | A |
| Ex. 7 | 7 | −1.0 | A | A |
| Ex. 8 | 8 | −1.0 | A | A |
| Ex. 9 | 9 | −1.0 | A | A |
| Ex. 10 | 10 | −2.8 | A | A |
| Ex. 11 | 11 | 1.1 | A | B |
| Ex. 12 | 12 | −4.3 | A | A |
| Ex. 13 | 18 | −2.2 | A | A |
| Ex. 14 | 19 | −2.0 | A | A |
| Ex. 15 | 20 | 0.9 | A | B |
| Ex. 16 | 21 | 0.0 | A | A |
| Ex. 17 | 23 | 2.0 | A | B |
| Ex. 18 | 26 | 0.5 | A | B |
| Comp. Ex. 1 | 13 | 3.7 | C | C |
| Comp. Ex. 2 | 14 | 4.5 | C | C |
| Comp. Ex. 3 | 15 | 4.8 | C | C |
| Comp. Ex. 4 | 16 | 5.9 | C | C |
| Comp. Ex. 5 | 17 | 3.1 | C | C |
| Comp. Ex. 6 | 22 | 3.5 | C | C |
| Comp. Ex. 7 | 24 | 4.5 | C | C |
| Comp. Ex. 8 | 25 | 4.6 | C | C |
| Comp. Ex. 9 | 27 | 0.9 | C | C |
| Comp. Ex. 10 | 28 | −0.2 | C | C |

What is claimed is:

1. An ink comprising:
a pigment-containing matter containing a pigment;
an organic solvent;
water; and
a compound represented by General Formula (1) below,
wherein a difference (Ra−R₀) is 2.0 or less, where Ra is a distance between a Hansen solubility parameter of the organic solvent and a Hansen solubility parameter of the pigment-containing matter determined by a Hansen solubility sphere method, and R₀ is an interaction radius of the pigment-containing matter determined by the Hansen solubility sphere method: 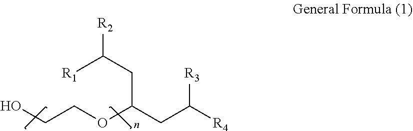
where R₁, R₂, R₃, and R₄ each independently represent a hydrogen atom or an alkyl group having 1 or more but 5 or less carbon atoms, and n represents an integer of 3 or more but 11 or less.

2. The ink according to claim 1, wherein the difference (Ra−R₀) is 0 or less.

3. The ink according to claim 1, wherein the compound represented by the General Formula (1) is a compound represented by General Formula (2) below: 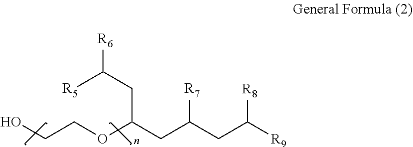
where R₅, R₆, R₇, R₈, and R₉ each independently represent a hydrogen atom or an alkyl group having 1 or more but 5 or less carbon atoms, and n represents an integer of 3 or more but 11 or less.

4. The ink according to claim 1, wherein the compound represented by the General Formula (1) is a compound represented by General Formula (3) below: 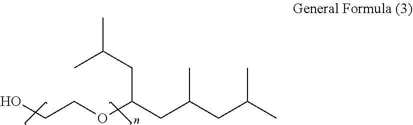
where n represents an integer of 3 or more but 11 or less.

5. The ink according to claim 1, wherein the n is an integer of 6 or more but 9 or less.

6. The ink according to claim 1, wherein the pigment-containing matter contains the pigment and a copolymer, the copolymer containing a constituting unit represented by General Formula (4) below and a constituting unit represented by General Formula (5) below: 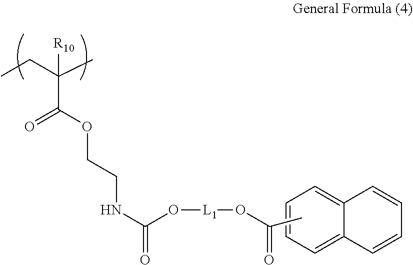
where R₁₀ is a hydrogen atom or a methyl group and L₁ is an alkylene group having 2 or more but 18 or less carbon atoms, 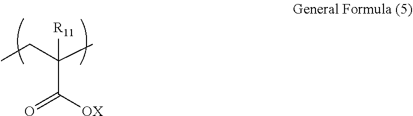
where R₁₁ is a hydrogen atom or a methyl group and X is a hydrogen atom or a cation.

7. The ink according to claim 1, wherein the pigment-containing matter contains a styrene acrylic resin-coated pigment that is the pigment whose surface is at least partially coated with a styrene acrylic resin.

8. The ink according to claim 1, wherein the organic solvent is at least one selected from the group consisting of 1,3-propanediol and glycerin.

9. An ink stored container comprising
the ink according to claim 1.

10. A printing device comprising:
an ink stored container that comprises an ink; and
an ink applying unit configured to apply the ink stored in the ink stored container,
wherein the ink comprises:
a pigment-containing matter containing a pigment;
an organic solvent;
water; and
a compound represented by General Formula (1) below, and
wherein a difference (Ra−R₀) is 2.0 or less, where Ra is a distance between a Hansen solubility parameter of the organic solvent and a Hansen solubility parameter of the pigment-containing matter determined by a Hansen solubility sphere method, and R₀ is an interaction radius of the pigment-containing matter determined by the Hansen solubility sphere method; 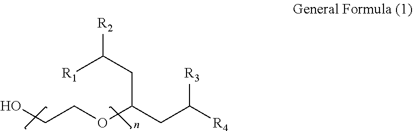
where R₁, R₂, R₃, and R₄ each independently represent a hydrogen atom or an alkyl group having 1 or more but 5 or less carbon atoms, and n represents an integer of 3 or more but 11 or less.

11. A printing method comprising
applying an ink,
wherein the ink comprises:
a pigment-containing matter containing a pigment;
an organic solvent;
water; and
a compound represented by General Formula (1) below, and
wherein a difference (Ra−R₀) is 2.0 or less, where Ra is a distance between a Hansen solubility parameter of the organic solvent and a Hansen solubility parameter of the pigment-containing matter determined by a Hansen solubility sphere method, and R₀ is an interaction radius of the pigment-containing matter determined by the Hansen solubility sphere method; 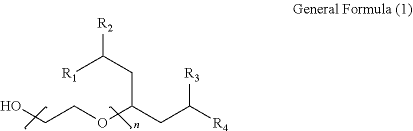
where R₁, R₂, R₃, and R₄ each independently represent a hydrogen atom or an alkyl group having 1 or more but 5 or less carbon atoms, and n represents an integer of 3 or more but 11 or less.
